(19) United States
(12) Patent Application Publication
(10) Pub. No.: US 2022/0153512 A1
(43) Pub. Date: May 19, 2022

(54) PREPARATION SYSTEM FOR EXTRACTING A PRODUCT CONTAINED IN A CAPSULE

(71) Applicant: STAS I.P. B.V., Eindhoven (NL)

(72) Inventor: Marinus Barbara Arnoldus Maria STAS, Eindhoven (NL)

(21) Appl. No.: 17/602,789

(22) PCT Filed: Apr. 10, 2020
(86) PCT No.: PCT/NL2020/050244

§ 371 Date: Oct. 11, 2021

(30) Foreign Application Priority Data
Apr. 11, 2019 (NL) 2022931

(51) Int. Cl. B65D 85/804; A47J 31/36

(52) U.S. Cl. CPC B65D 85/8064; A47J 31/3623

(57) ABSTRACT

The preparation system has a capsule 11 which is provided with a conical side wall 13, a first end 13a of which has a larger outer diameter than the second end 13b. The capsule 11 is provided at the first end 13a with an outwardly projecting flange 15 to which a foil 19 is attached which foil closes the capsule. The preparation device 1 has a pressure cylinder 3 which is slid over the capsule 11 and presses the flange 15 against a counter plate 5. The pressure cylinder has to be liquid-tight in contact with the capsule. The outer diameter of the first end 13a of the side wall 13 of the capsule being larger than the inner diameter of the pressure cylinder 3. When the pressure cylinder is slid over the capsule, the capsule will compress in the axial direction, such that the deformed part of the side wall 13 forms a liquid-tight seal between the capsule 11 and the pressure cylinder 3.

### TECHNICAL FIELD OF THE INVENTION

The invention relates to a preparation system for preparing a beverage by extracting a product contained in a capsule, in particular ground coffee beans, in a suitable preparation device, said preparation system comprising:
a capsule with:
   an at least partly conical side wall with two ends, of which a first end has a larger outer diameter than the second end, the outer diameter of the side wall from the second end until the first end gradually increases in diameter and does not jump in diameter,
   an outwardly projecting flange present at the first end of the side wall,
   a bottom closing the capsule at the second end of the side wall,
   a foil with its edge on the flange and attached to the flange and closing the capsule at the first end,
a preparation device into which the capsule can be placed and which is equipped with:
   a counter plate,
   a pressure cylinder which is pushed over the side wall of a capsule introduced into the preparation device and presses with one end against the flange of the capsule, thereby pressing this flange against the counter plate in the preparation device, the end of the pressure cylinder being stepped such that in the pressure direction of the pressure cylinder an inner part of the end of the pressure cylinder projects from an outer part of the end of the pressure cylinder.

The pressure cylinder has to be in liquid-tight contact with the capsule so that no liquid can leak between the flange and the pressure cylinder. The pressure cylinder can have a circular cylindrical or conical shape.

### BACKGROUND OF THE INVENTION

Such a preparation system is known from WO2013/184652A1. The capsule of this known preparation system is provided with an annular tray which receives the end of the pressure cylinder and then deforms when the pressure cylinder is moved to the working position to obtain a liquid-tight seal. The capsules of this well-known preparation system are an alternative to the capsules that Nestlé offers under the brand name Nespresso®. In the preparation devices that cooperate with these capsules, the pressure cylinder is provided with irregularities that leak with capsules without special provisions, which makes the capsules actually unusable. The Nespresso® preparation system capsule has an elastic layer on the flange that contacts the uneven end of the pressure cylinder during extraction and provides a liquid-tight seal between the pressure cylinder and the capsule flange. The disadvantage of this known capsule is that an extra sealing element has to be applied, which increases the production costs of the capsule.

### SUMMARY OF THE INVENTION

An object of the invention is to provide a capsule for use in the Nespresso® preparation system, whereby a better sealing is obtained during use than with the capsule known from WO2013/184652A1. To this end, the preparation system according to the invention is characterized in that:
from the second end to a first location at a first distance from the first end the outer diameter of the side wall of the capsule is less than the inner diameter of the pressure cylinder at the end,
from the first place to a second place at a second distance from the first end, which second distance is smaller than the first distance, the outer diameter of the side wall of the capsule is less than the outer diameter of the inner part of the end of the pressure cylinder, and
from the second place to the first end the outer diameter of the side wall of the capsule is greater than the outer diameter of the inner part of the end of the pressure cylinder.

When moving the pressure cylinder over the capsule, the capsule is first centered in the pressure cylinder by the part of the side wall with a diameter greater than the inner diameter of the inner part of the end of the pressure cylinder. When the pressure cylinder is moved further, due to the increasing diameter of the side wall of the capsule, from a certain point this side wall is no longer pressed radially inwards, but is pressed axially together. The compressed part of the side wall forming a seal between the capsule and the pressure cylinder.

An embodiment of the preparation system according to the invention is characterized in that from a third place at a third distance from the first end, which third distance is smaller than the second distance, up to the first end, the side wall of the capsule is cylindrical. The end of this cylindrical part facing away from the flange forms a hinge. During deformation of the side wall of the capsule by the pressure cylinder, the side wall of the capsule rotates inwards and folds around the inner part of the end of the pressure cylinder forming a seal between the capsule and the pressure cylinder. This provides a better seal than without the presence of this cylindrical part of the side wall of the capsule. Hereby, the side wall of the capsule deforms plastically.

Preferably, a part of the side wall of the capsule adjacent to the flange is made thicker or thinner over the entire circumference than the remaining part of the side wall. As a result, more material deforms when the pressure cylinder is slid over the capsule, so that an even better seal between the flange and the pressure cylinder is obtained.

A further embodiment of the preparation system according to the invention is characterized in that the side wall of the capsule is provided with a circumferential slot and/or circumferential rib. As a result, the inner edge or end of the pressure cylinder, when sliding over the capsule, hooks behind a boundary edge of the circumferential slot or behind the circumferential rib, after which the part of the side wall between this circumferential slot or circumferential rib and the flange is pressed together by the pressure cylinder. The pressed-together part forms a seal between the flange and the end of the pressure cylinder.

Yet a further embodiment of the preparation system according to the invention is characterized in that an annular reinforcing element is present in the capsule which is at least partly in contact with the inner side of the side wall of the capsule at the flange and extends over the entire inner circumference. This reinforcing element forms a reinforcement of the side wall of the capsule. If this reinforcement is designed as a ring, this ring can for instance have an L-shaped, rectangular or round shape. This reinforcing element can be of rigid, hard material if the part of the side wall where the reinforcing element is located serves to center the capsule with respect to the pressure cylinder, or of a supple soft compressible material if the part of the side wall where the reinforcing element is located serves to be crushed or otherwise deformed.

Preferably, the annular reinforcing element is provided with an annular first part being in contact with the inside of the side wall and an annular second part extending parallel to the foil.

Further, the reinforcing element preferably comprises a sleeve-shaped part that for at least part of its length is in contact with the inside of the capsule. This sleeve-shaped part forms a reinforcement of the wall of the capsule, so that the capsule wall can be made thin.

### BRIEF DESCRIPTION OF THE DRAWINGS

The invention will be explained in more detail below with reference to illustrative embodiments of the preparation system according to the invention shown in the drawings, wherein:

FIG. 1 is a sectional view of a first embodiment of the preparation system;

FIG. 2 is a side view of the capsule of the preparation system shown in FIG. 1;

FIG. 3 is a side view of the preparation system with the capsule shown in FIG. 1;

FIG. 4 shows the preparation system with the capsule shown in FIG. 1 during the formation of a seal;

FIG. 5 is a sectional view of the capsule of a second embodiment of the preparation system; and

FIG. 6 is a sectional view of the capsule of a third embodiment of the preparation system.

### DETAILED DESCRIPTION OF THE DRAWINGS

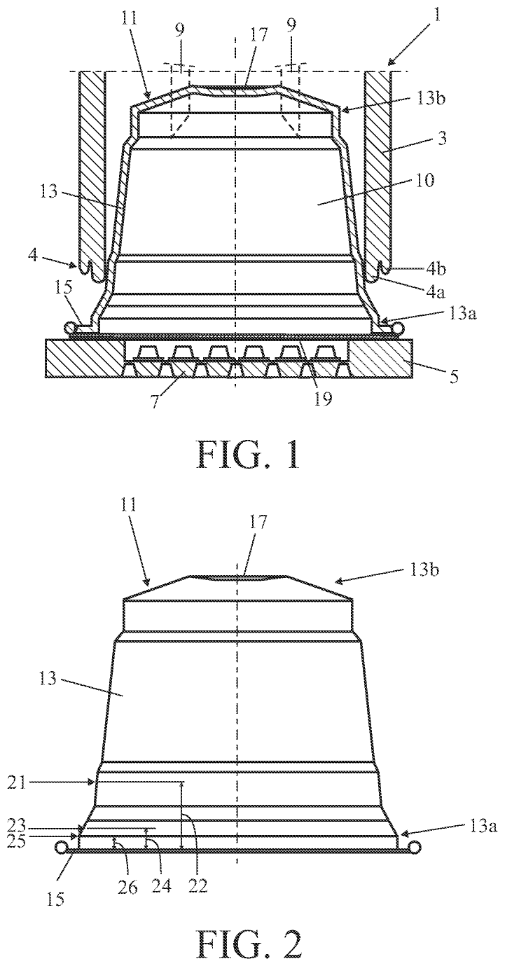

FIG. 1 shows a first embodiment of the preparation system according to the invention in cross-section in which only the parts of the preparation apparatus necessary for the explanation are shown. The preparation system consists of a preparation device 1 and co-acting capsules 11 which can be introduced into the preparation device. Each capsule is provided with a conical side wall 13 with two ends, a first end 13a of which has a larger outer diameter than the second end 13b. At the first end 13a, the capsule 11 is provided with an outwardly projecting flange 15 on which a sealing foil 19 is mounted and at the second end 13b, the capsule is provided with a bottom 17.

The preparation device 1 has a circular cylindrical pressure cylinder 3 which, for extracting the ground coffee beans present in the capsule introduced into the preparation device, is slid over the side wall 13 of the capsule 11 and with an end presses the flange 15 of the capsule against a counter plate 5 present in the preparation device. This end 4 of the pressure cylinder is provided with unevenness, for example protruding serrations or teeth. The counter plate 5 is provided with a wafer structure 7 which is provided with through-flow openings for allowing the prepared liquid to flow out of the device.

The end 4 of the pressure cylinder 3 is stepped such that in the pressure direction of the pressure cylinder 3 (this is towards the counter plate) an inner part 4a of the end 4 of the pressure cylinder protrudes relative to an outer part 4b of the end 4 of the pressure cylinder.

Simultaneously with the displacement of the pressure cylinder, the bottom 17 of the capsule is pierced by needles 9 present in the device through which hot water is injected under pressure into the capsule. Due to pressure build-up in the capsule, the foil 19 is pressed against the wafer structure 7 and thereby tears open at various places, so that the extract can flow out of the capsule. The pressure cylinder has to connect liquid-tight to the capsule so that no liquid can leak between the flange and the pressure cylinder.

In FIG. 2, the capsule 11 is shown separately in side view. The outer diameter of the side wall 13 of the capsule 11 is from the second end 13b to a first location 21 at a first distance 22 from the first end 13a, smaller than the inner diameter of the pressure cylinder 3 at the end 4. From the first place 21 to a second place 23 at a second distance 24 from the first end 13a, which is smaller than the first distance 22, the outer diameter of the side wall 13 of the capsule 11 is smaller than the outer diameter of the inner part 4a of the end 4 of the pressure cylinder 3. During the displacement of the pressure cylinder 3 over a first distance, a slightly conical part of the side wall 13 will be pressed radially inwards, so that the capsule 11 centers in the pressure cylinder 3.

From the second place 23 to the first end 13a, the outer diameter of the side wall 13 of the capsule 11 is larger than the outer diameter of the inner part 4a of the end 4 of the pressure cylinder 3. As a result, when the pressure cylinder 3 is moved further, the side wall 13 folds around the inner part 4a of the end 4 of the pressure cylinder 3. By designing the side wall 13 of the capsule 11 cylindrically from a third place 25 at a third distance 26 from the first end 13a, which is smaller than the second distance 24, up to the first end 13a, the side wall 13 can be formed better around the inner part 4a of the pressure cylinder 3 because the end of the cylindrical part acts as a hinge when deforming the side wall 13.

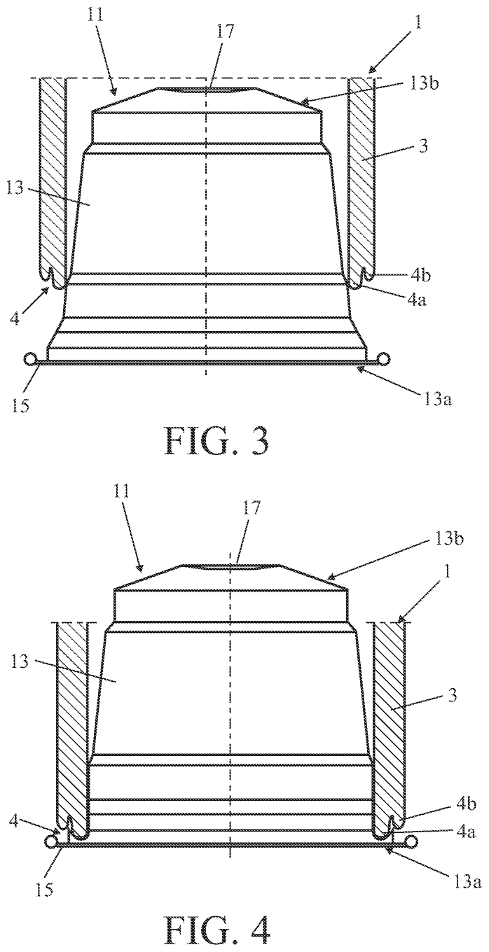

In FIGS. 3 and 4, the capsule preparation system is shown in side view during the centering of the capsule relative to the pressure cylinder, respectively, while forming a seal. In the situation shown in FIG. 3, the inside of the pressure cylinder 3 just comes into contact with the outside of the side wall 13 of the capsule 11, this is at the first place 21 on the side wall of the capsule. As the pressure cylinder 3 is moved further over the capsule 11, the side wall 13 of the capsule will be pressed in radial direction and due to the slightly increasing diameter of the side wall of the capsule, the frictional resistance between the pressure cylinder and the capsule will increase.

Upon reaching a kink in the side wall 13 of the capsule 11, the pressure cylinder 3 will then compress the side wall 13 in the axial direction, with the side wall 13 pivoting inward at the third place 25. This is shown in FIG. 4 wherein the side wall 13 folds around the inner part 4a of the end 4 of the pressure cylinder 3, so that a circular tray is formed which forms a seal between the pressure cylinder and the capsule 11.

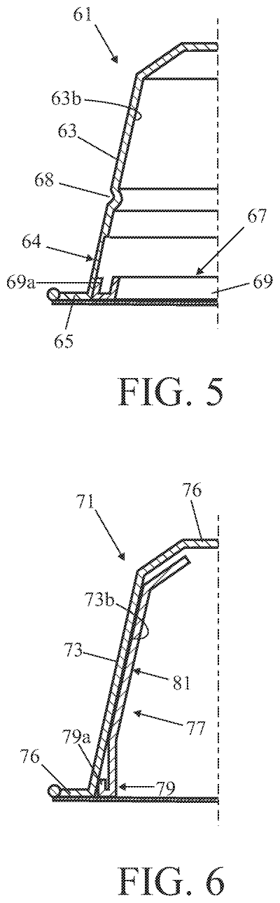

In the embodiment shown in FIG. 5, in the capsule 61 there is a reinforcing element 67 which contacts the inside 63b of the side wall 63 of the capsule at the location of the flange 65. This reinforcing element 67 is formed by a ring 69 extending over the entire inner circumference and having a U-shaped cross-section. The outer upright wall 69a of the ring 69 contacts the inner side 63b of the side wall 63 of the capsule 61. This reinforcing element 67 ensures that the side wall 63 of the capsule 61 when pressing in, hinges about the edge of the reinforcing element that contacts the inside of the sidewall 63 of the capsule.

A part 64 of the side wall 63 of the capsule 61 adjacent to the flange 65 is over the entire circumference thinner than the remaining part of the side wall 63. As a result, more material deforms during sliding of the pressure cylinder over the capsule, so that an even better sealing between the flange and the pressure cylinder is obtained.

Furthermore, the side wall 63 of the capsule 61 is provided with a peripheral slot 68. As a result, the inner edge of the pressure cylinder hooks behind a bounding edge of the peripheral slot 68 when sliding over the capsule, after which the part of the side wall between this peripheral slot and the flange is pressed together by the pressure cylinder and forms a seal.

Instead of the reinforcing element 67, a ring of hard material can also be clamped in the capsule 61, which ring is provided with ridges (type of toothing) over the outer circumference and is formed according to the toothing present on the inside of the pressure cylinder. In this case, during use, the side wall 63 of the capsule is clamped between the pressure cylinder and the ribbed ring and a seal is formed between the pressure cylinder and the capsule.

In the embodiment shown in FIG. 6, the reinforcing element 77 next to an annular part 79 with an upright edge 79a which contacts the inside 73b of the side wall 73 of the capsule 71 at the flange 75, further has a sleeve-shaped part 81 that over a part of the length is in contact with the inner side 73b of the capsule 71. This sleeve-shaped part forms a reinforcement of the wall of the capsule, so that the capsule wall 73 can be made thin.

The capsule is preferably made of aluminum or other metal. However, the capsule can also be made of plastic or fibrous material. If the capsule is made of aluminum, it is preferably provided with a plastic layer or coating for protection, for example PP, PET or PE. In addition to a glossy layer, this coating can also contain a matte layer. A non-slip layer on the outside of the side wall is preferred. In a possible embodiment a thin sleeve of aluminum, fiber material or plastic is applied over the capsule, which sleeve deforms in the manner described above to form a seal.

Although the present invention is elucidated above on the basis of the given drawings, it should be noted that this invention is not limited whatsoever to the embodiments shown in the drawings. The invention also extends to all embodiments deviating from the embodiments shown in the drawings within the scope of the invention defined by the appended claims.

1. Preparation system for preparing a beverage by extracting a product contained in a capsule, in particular ground coffee beans, in a suitable preparation device, said preparation system comprising:
a capsule with:
an at least partly conical side wall with two ends, of which a first end has a larger outer diameter than the second end, the outer diameter of the side wall from the second end until the first end gradually increases in diameter and does not jump in diameter,
an outwardly projecting flange present at the first end of the side wall,
a bottom closing the capsule at the second end of the side wall,
a foil with its edge on the flange and attached to the flange and closing the capsule at the first end,
a preparation device into which the capsule can be placed and which is equipped with:
a counter plate,
a pressure cylinder which during use is to be pushed over the side wall of a capsule introduced into the preparation device and during use will press with one end against the flange of the capsule, thereby pressing this flange against the counter plate in the preparation device, the end of the pressure cylinder being stepped such that in the pressure direction of the pressure cylinder an inner part of the end of the pressure cylinder projects from an outer part of the end of the pressure cylinder,
wherein:
from the second end to a first-place at a first distance from the first end the outer diameter of the side wall of the capsule is less than the inner diameter of the pressure cylinder at the end, at said first place seen in longitudinal section the side wall being straight,
from the first place to a second place at a second distance from the first end, which second distance is smaller than the first distance, the outer diameter of the side wall of the capsule is less than the outer diameter of the inner part of the end of the pressure cylinder, and
from the second place to the first end the outer diameter of the side wall of the capsule is greater than the outer diameter of the inner part of the end of the pressure cylinder.

2. Preparation system according to claim 1, wherein from a third place at a third distance from the first end, which third distance is smaller than the second distance, up to the first end, the side wall of the capsule is cylindrical.

3. Preparation system according to claim 1, wherein a part of the side wall of the capsule adjacent to the flange is made thicker or thinner over the entire circumference than the remaining part of the side wall.

4. Preparation system according to claim 1, wherein the side wall of the capsule is provided with a circumferential slot and/or circumferential rib.

5. Preparation system according to claim 1, wherein an annular reinforcing element is present in the capsule which is at least partly in contact with the inner side of the side wall of the capsule at the flange and extends over the entire inner circumference.

6. Preparation system according to claim 5, wherein the annular reinforcing element is provided with an annular first part being in contact with the inside of the side wall and an annular second part extending parallel to the foil.

7. Preparation system according to claim 5, wherein the reinforcing element comprises a sleeve-shaped part that for at least part of its length is in contact with the inside of the capsule.
